(19) United States
(12) Patent Application Publication
(10) Pub. No.: US 2014/0029124 A1
(43) Pub. Date: Jan. 30, 2014

(54) DECORATIVE ELEMENT

(71) Applicant: SHEEHAN PROJECTS LIMITED, GLASGOW (GB)

(72) Inventors: Linda Sheehan, Glasgow (GB); James Daniel Sheehan, Glasgow (GB)

(73) Assignee: SHEEHAN PROJECTS LIMITED, GLASGOW (GB)

(21) Appl. No.: 13/952,283

(22) Filed: Jul. 26, 2013

(30) Foreign Application Priority Data
Jul. 26, 2012 (GB) GB 1213307.0

(51) Int. Cl. G02B 5/20; G02B 7/00

(52) U.S. Cl. CPC G02B 5/201; G02B 7/006
USPC 359/890; 359/891; 428/101

(57) ABSTRACT

A decorative feature for a transparent surface is disclosed. The decorative feature for a transparent surface includes a plurality of decorative elements. Each element includes a main body having at least one substantially planar first portion or lens which at least partially allows the transmission of light. The decorative elements are interconnectable to form an assembly and the installed assembly includes a plurality of layers of lenses. The plane of each lens is substantially parallel to the plane of the transparent surface.

### CROSS-REFERENCE TO RELATED APPLICATIONS

This application claims the benefit of United Kingdom Patent Application No. GB 1213307.0, filed Jul. 26, 2012, which is incorporated by reference herein in its entirety.

### FIELD OF INVENTION

The present invention relates to decorative features or elements which can be attached to surfaces. In particular, but not exclusively, the invention relates to decorative elements which can be removably attached to transparent surfaces, such as glass panes.

### BACKGROUND TO THE INVENTION

The present invention resolves limitations in known glass decorative features. Leaded or stained glass is typically bespoke to a specific glass pane and involves low volume production. These techniques require a high level of skill and a degree of measurement and alignment when attaching to the glass pane. The installation time can be significant, and the cost is high due to the need for bespoke development and subsequent skilled labour installation costs.

Once installed, the decorative glass appearance cannot easily be altered and replacement of the current decorative leaded or stained glass or decorative panel is required to alter the decorative view of the existing glass pane.

Furthermore, the customer's artistic input, if any, is limited to the initial design of the decorative glass features. The installed decorative features may also limit the capability to clean the existing glass pane.

In the prior art systems, colours are prone to fade in prolonged UV exposure, thus losing their original decorative effect. There are also limitations to the manufacturing methods available to create the prior art systems, and there is limited capability to use recyclable materials.

GB2297525 describes an inexpensive decorative system. Nevertheless, improvements to known systems are possible and desirable. In particular, it is desirable to offer greater design freedom, both at the time of first installation and subsequent to this.

### SUMMARY OF THE INVENTION

According to a first aspect of the present invention there is provided a decorative feature for a transparent surface comprising:

a plurality of decorative elements, each element comprising a main body comprising at least one substantially planar first portion or lens which at least partially allows the transmission of light,

wherein the decorative elements are interconnectable to form an assembly, the installed assembly comprising a plurality of layers of lenses, the plane of each lens being substantially parallel to the plane of the transparent surface.

Hereinafter the term “lens” will be used for the first portion. However, the term is not to be understood as implying that the first portion necessarily provides any optical lensing in the technical sense.

Each lens may be configured to allow the transmission of light at only particular frequencies or a range of frequencies. One or more lens may be coloured. Each decorative element may comprise a plurality of lenses and the lenses may be of a plurality of colours. The assembly may include layered lenses of different colour such that the light which has been transmitted through the layered lenses is of a different colour to the lenses.

The decorative elements may be interconnectable such that the formed assembly comprises layers of lenses in which the lenses are offset or overlap with each other.

Each lens may be coated or treated to provide UV resistance.

The decorative element may comprise a frame. The term is not to be understood as implying any geometric limitations to the second portion.

The frame may include or define an aperture for each lens. The or each aperture may include a recess, groove, lip or the like for retaining the lens.

Each decorative element may be removably attachable to the transparent surface. Each decorative element may be removably attachable to another decorative element.

Each decorative element may include a fastening member for fastening the decorative element to the transparent surface or to another decorative element. The frame may include or define an aperture for the fastening member. The aperture may include a recess, groove, lip or the like for retaining the fastening member. The fastening member may comprise a lens.

The fastening member may comprise a contact surface and fastening means. The fastening means may comprise an adhesive applied to the contact surface. The decorative element may include a peelable cover layer for protecting the adhesive.

The fastening member may extend from a first side of the main body such that the contact surface is spaced from the main body to provide a gap when the decorative element is attached to the transparent surface or another decorative element.

Each frame may define a recess on a second opposing side of the main body for receiving the contact surface of an adjacent decorative element. The contact surface of one decorative element may be attachable to a base of the recess of an adjacent decorative element.

Alternatively or in addition, the decorative elements may be interconnectable using an interference fit between adjacent elements. The recess and corresponding contact surface may provide the interference fit between two adjacent decorative elements.

The fastening member may be rotatably attached to the main body such that, in use, the main body is rotatable relative to at least the transparent surface. The fastening member may be rotatably attached to the main body such that each decorative element of the assembly is rotatable relative to another decorative element of the assembly.

The fastening member may be provided at a central location of the main body so that the main body is rotatable about its centre. The main body may be symmetrical about at least one axis in the plane.

According to a second aspect of the present invention there is provided a decorative feature for a transparent surface comprising:

at least one decorative element comprising a main body and a fastening member for fastening the decorative element to the transparent surface,

wherein the fastening member is rotatably attached to the main body such that, in use, the main body is rotatable relative to the transparent surface.

The main body may be substantially planar, the plane being substantially parallel to the plane of the transparent surface. The fastening member may be rotatably attached to the main body such that, in use, the main body is rotatable within the plane of the transparent surface.

The fastening member may be provided at a central location of the main body so that the main body is rotatable about its centre. The main body may be symmetrical about at least one axis in the plane.

The decorative element may be removably attachable to the transparent surface. The fastening member may comprise a contact surface and fastening means. The fastening means may comprise an adhesive applied to the contact surface. The decorative element may include a peelable cover layer for protecting the adhesive prior to installing the decorative element at the transparent surface.

Alternatively, the fastening means may comprise suction means and the fastening member may be configured to generate at least a partial vacuum between the contact surface and the transparent surface. Alternatively, the fastening means may comprise one or more fixings.

The fastening member may extend from the main body such that the contact surface is spaced from the main body to provide a gap when the decorative element is attached to the transparent surface. This assists unhindered rotation of the decorative element relative to the transparent surface.

The decorative element may include locking means for selectively locking the position of the main body relative to the fastening member. The locking means may comprise a movable stop, fastener or grip or an adhesive.

The decorative element may comprise at least one lens which at least partially allow the transmission of light. The lens may be substantially planar, the plane being substantially parallel to the plane of the transparent surface. The lens may be configured to allow the transmission of light at only particular frequencies or a range of frequencies. The lens may be coloured.

The decorative element may comprise at least one frame. The frame may include or define an aperture for each lens. The or each aperture may include a recess, groove, lip or the like for retaining the lens.

The frame may include or define an aperture for the fastening member. The aperture may include a recess, groove, lip or the like for retaining the fastening member. The fastening member may comprise a lens.

### BRIEF DESCRIPTION OF THE DRAWINGS

Embodiments of the present invention will now be described, by way of example only, with reference to the accompanying drawings in which:

FIG. 1 is a perspective view of decorative elements applied to a household window;

FIG. 2 is a perspective view of decorative elements applied to a household door;

FIG. 3 is a front view of a household door and side panes with a decorative arrangement;

FIG. 4 is a perspective view of a single decorative element attached to a glass pane;

FIG. 5 is an exploded view of a single decorative element;

FIG. 6 is a front view of the decorative element of FIG. 5;

FIG. 7 is a rear view (looking through the glass pane) of the decorative element of FIG. 5;

FIG. 8 is a side view of the decorative element of FIG. 5;

FIG. 9 is an opposite side view of the decorative element of FIG. 5;

FIG. 10 is a top view of the decorative element of FIG. 5;

FIG. 11 is a bottom view of the decorative element of FIG. 5;

FIG. 12 is a perspective view of the decorative element of FIG. 5;

FIG. 13 is a perspective view of the decorative element of FIG. 5 and showing cross-section view A-A of FIG. 12;

FIG. 14 is an exploded perspective view of the decorative element of FIG. 5 and showing cross-section view B-B of FIG. 12;

FIG. 15 is a front view of the decorative element of FIG. 5 and showing two different orientations;

FIG. 16 is a perspective view of an assembly of decorative elements; and

FIG. 17 is an exploded perspective view of another assembly of decorative elements.

### DETAILED DESCRIPTION OF ILLUSTRATIVE EMBODIMENTS

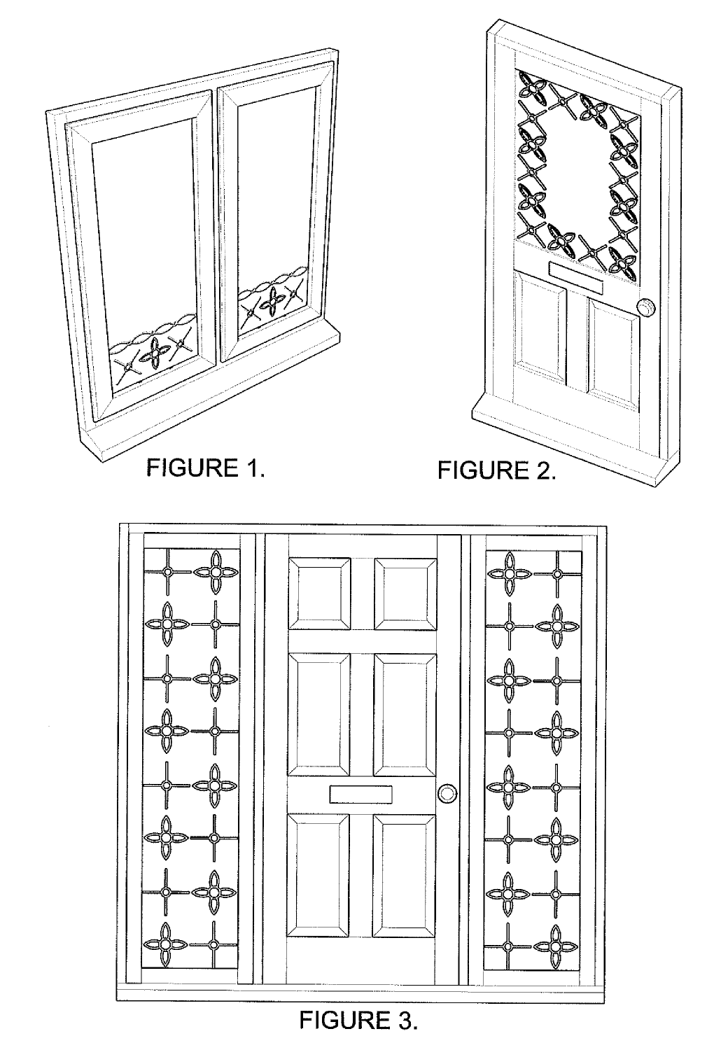

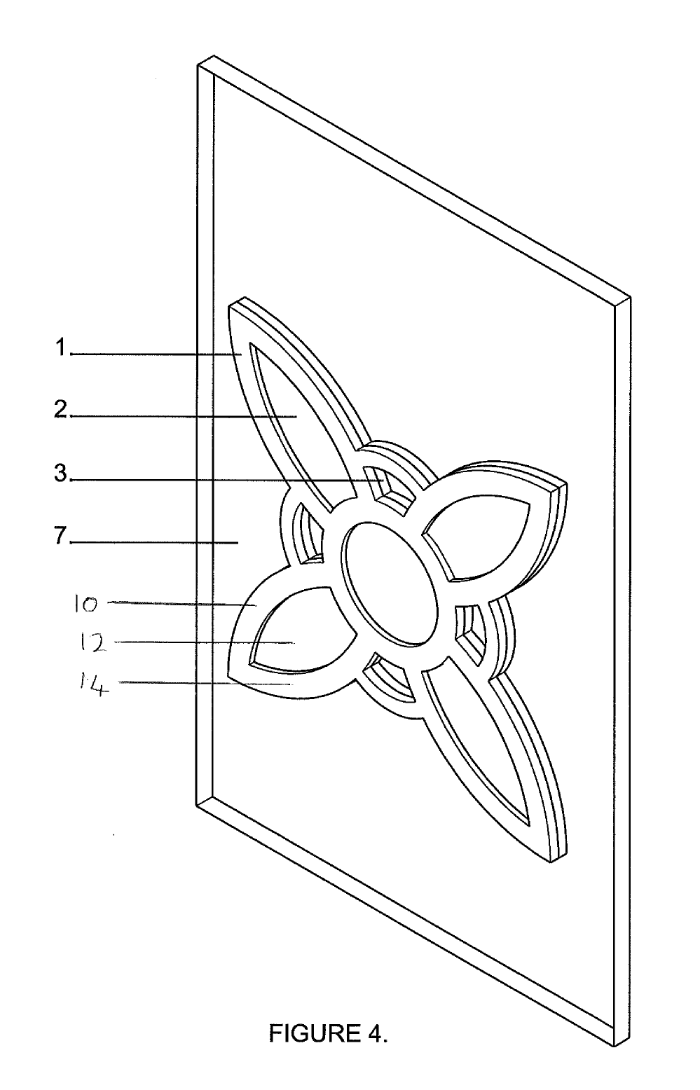

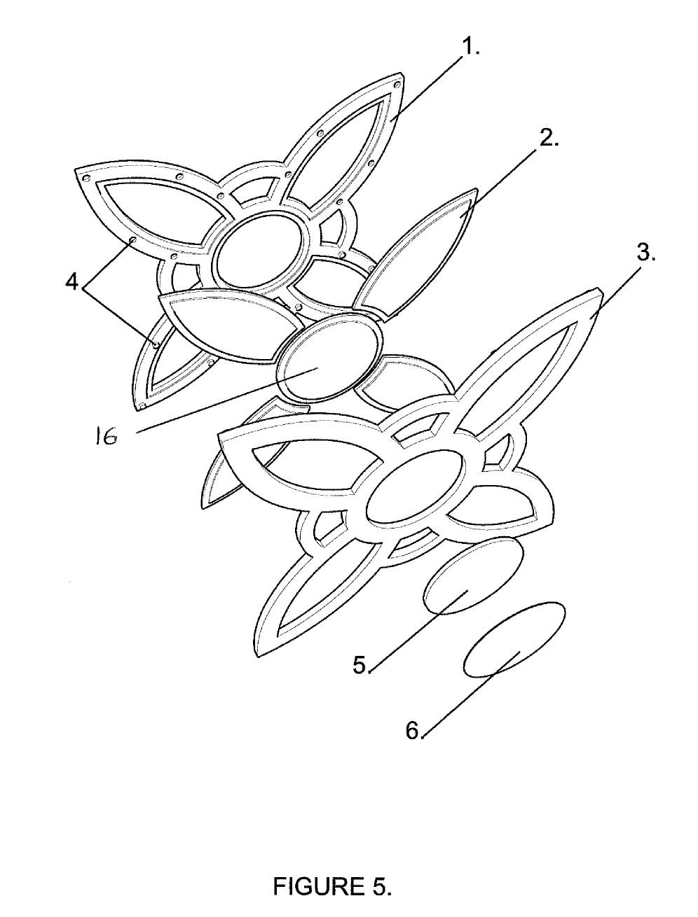

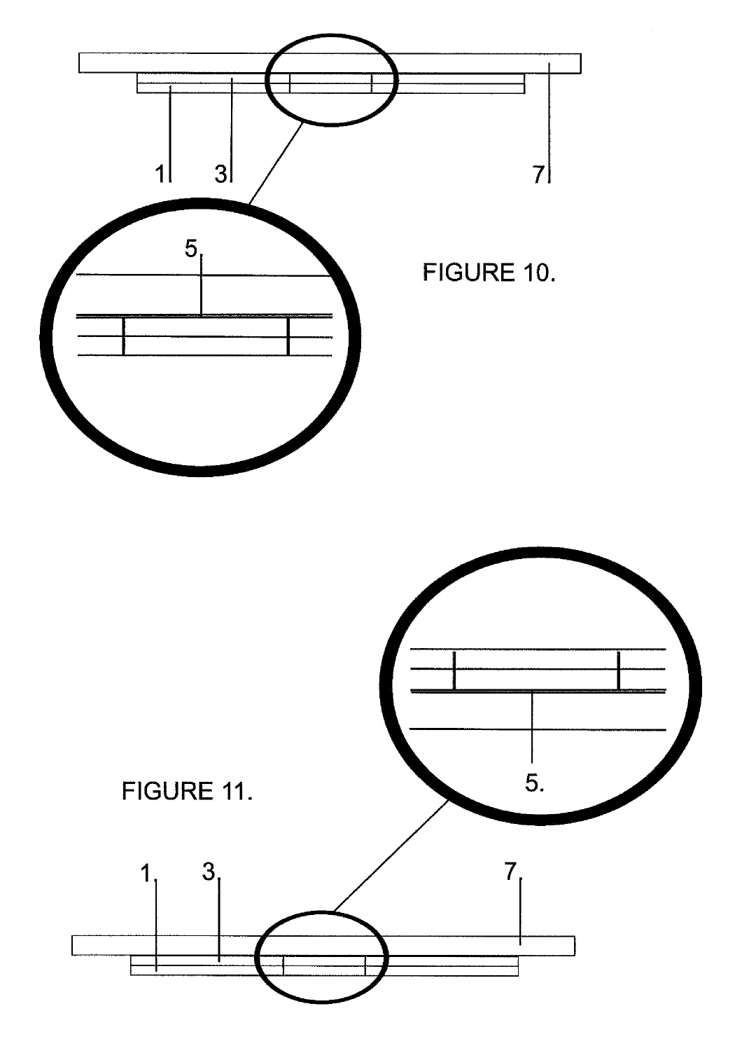

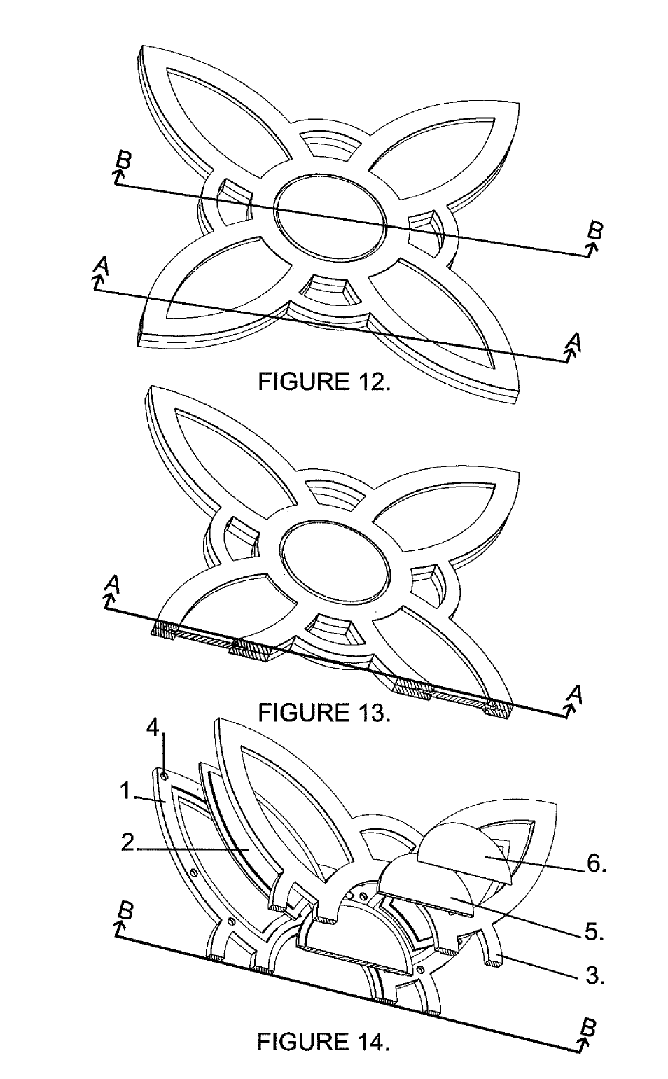

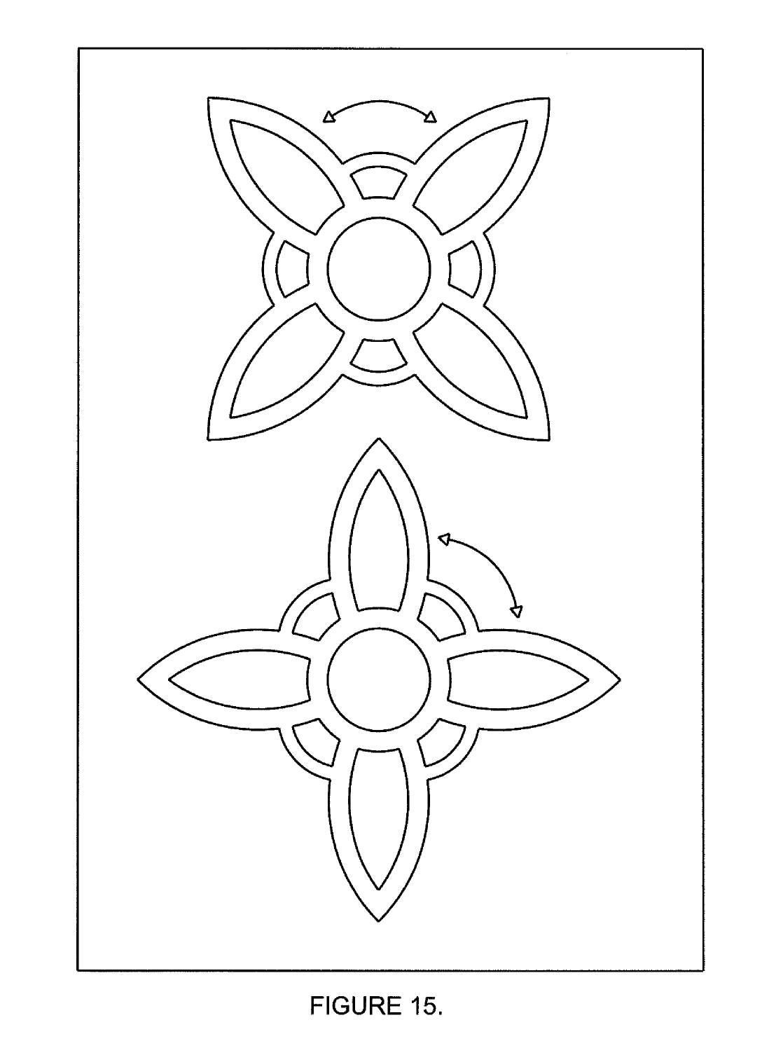

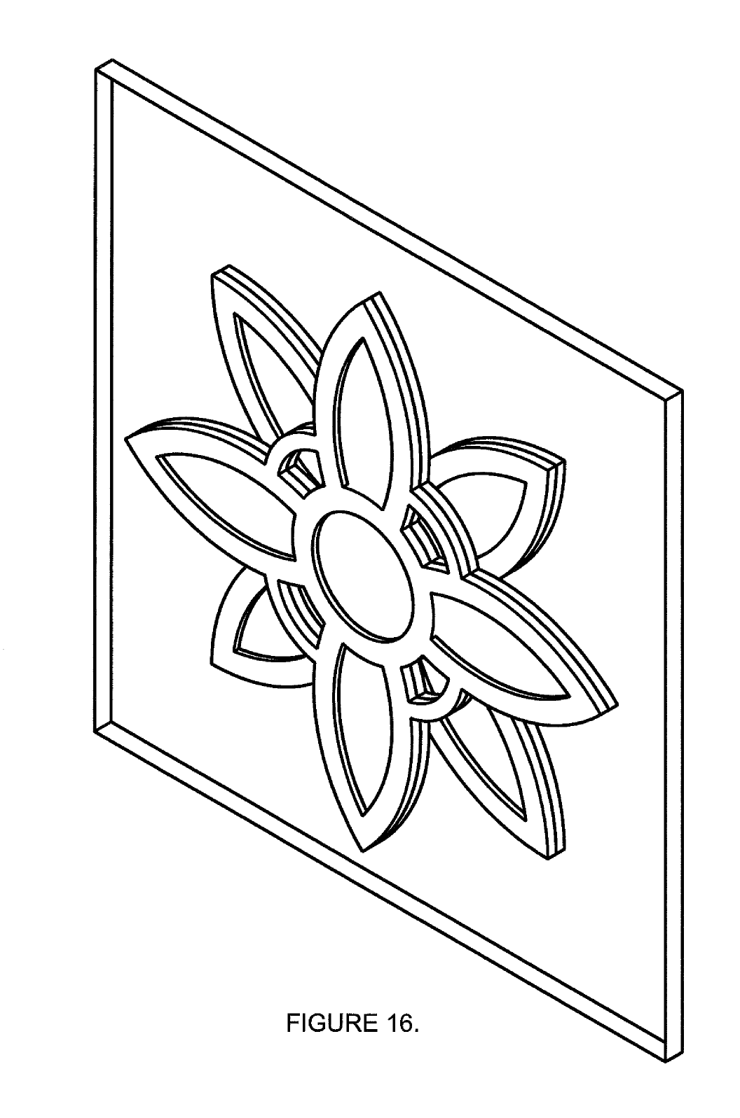

FIGS. 1 to 14 show a decorative element, each element comprising a main body 10. As shown in FIG. 4, the main body 10 includes a number of planar lenses 12 which are transparent and coloured to allow the transmission of light at certain frequencies. The main body 10 also includes a frame 14 which allows little or no light through (although the frame could also be transparent).

The decorative element can be attached to a transparent surface 7 such as a glass pane. A number of elements can be used together to create larger areas of decorative design. Examples of designs can be seen in FIGS. 1 to 3.

The decorative element includes a fastening member 16 for fastening the decorative element to the transparent surface 7. As best seen in FIG. 14, the fastening member 16 is a disc which fits within a recess defined by the frame 10. The fastening member 16 is rotatably attached to the frame 10 such that the main body 10 can be rotated relative to the fastening member 16, and therefore also rotated relative to the transparent surface.

With reference to FIG. 7, the attachment method is by a double sided adhesive patch 5. This is shown in a central location. This may not always be the case and several adhesive patches or fasteners may be used.

The application of a plurality of adhesive patches or fasteners on a single decorative element prevents the rotation of the decorative element. This could be used as locking means to prevent rotation.

The example illustrated in FIG. 12 shows section lines further detailed in FIG. 13 and FIG. 14. The sections are of A-A and B-B. The example section A-A shown in FIG. 13 shows the cut through of a decorative element comprising three portions: portions 1 to 3.

The section illustrated in FIG. 14 shows an exploded section cut through a decorative element made up of portions 1 to 3, adhesive patch layer 5 and the adhesive patch release lining paper 6. This example illustrates how the layers may comprise separate components.

Portions 1 and 3 comprise first and second halves of the frame 14. They can be of different decorative profiles but generally has a flat surface next to the existing glass pane. Portion 2 (lens) is made up of a singular component or a plurality of components, and these components are located between portions 1 and 3 (the frame). Portion 2 components are located and held in-situ by layers 1 and 3. The illustrated example in FIG. 14 shows that the layers are clasped together by small hidden fasteners 4. The components of portion 2 can have a variety of profiles, thicknesses, shapes, colours etc. and can change to suit the decorative element design. Portion 2 may or may not be transparent or translucent. In the present example they are opaque (this is for illustration purposes only, assume they are translucent/transparent). The decorative element illustrated in FIG. 14 shows the use of a small flange around the edges of the components (lenses) of portion 2. This design helps with the location of them during assembly. Portion 3 may have a mirror image design of portion 1. It will be generally flat, but it may have different designed profiles. The final profile will be depicted by the design and manufacturing processes.

The adhesive patch is clear and has a thickness that when attached onto portion 2 sits proud of portion 3. Portion 6 is the adhesive patch release lining paper, when attaching the decorative element this is removed completely.

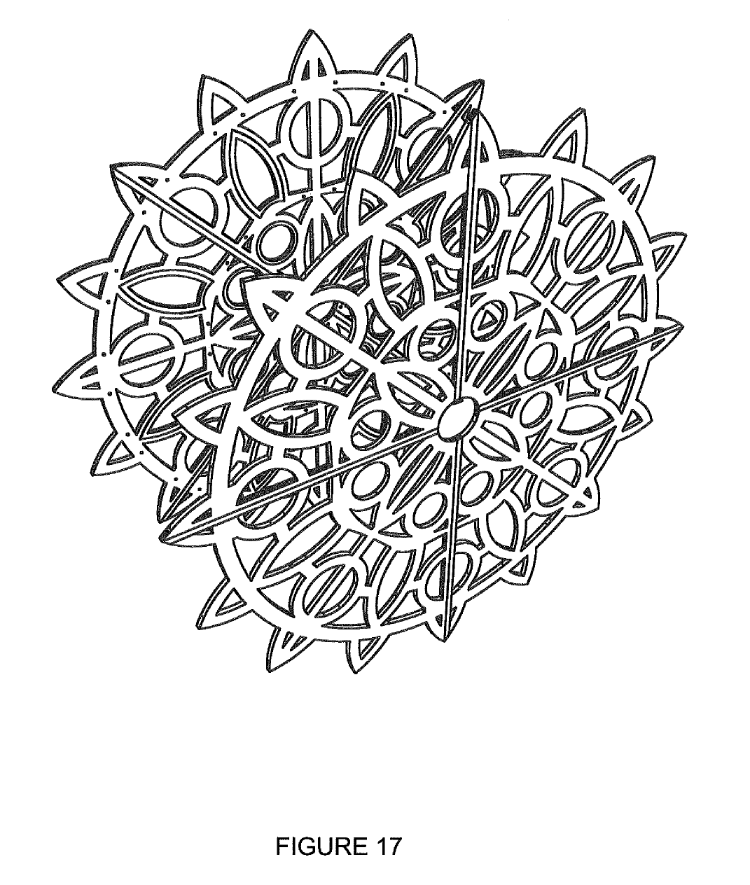

FIG. 17 shows a decorative element made up of two portions. The first portion is constructed of four quarter circle shaped components that are attached together side by side with a variety of small hidden fasteners or adhesives to create a single portion. This portion is then joined to the rotated opposing portion in such a manner according to design that it eliminates weakness in the component construction.

Examples illustrations of decorative element applications can be seen in FIGS. 1 to 3. The decorative elements can imitate frosted glass, leaded glass and/or stained glass.

During manufacturing, the lenses can be treated to incorporate additives to ensure UV resistance when installed. The adhesive used can also have UV resistant properties. The materials used can also be selected for their thermal properties, to minimise heat expansion and cold contraction when attached to the glass pane.

The adhesive is attached to the surface of the lens 12. Where the design accommodates, the variety of fasteners and adhesives may be positioned in a recessed area of the decorative element.

Attachment and detachment of the decorative element requires no specialised training. Installation time is minimal i.e. a decorative element can be attached in minutes. The decorative element is a removably attachable solution for adding decorative features to an existing glass pane i.e. they are not permanent in nature. The existing glass pane does not need to be removed for installation/de-installation.

The decorative element can be rotated and may be locked in position to provide an alternative decorative pattern. The rotation feature also permits easier cleaning of the glass pane.

The user has control over the final designs they can be arranged in a non-prescriptive manner to provide a personalised design. Moreover the decorative elements are removably attachable and can be repositioned to create a completely different overall design. The design can be seasonally changed in designs, colours and sizes to suit the current fashions in home designs.

The decorative elements are interconnectable to form a layered assembly. The installed assembly will then comprise a number of layers with lenses parallel to each other and the plane of the transparent surface 7.

This creates a decorative feature with a greater depth and three dimensional effect. The appearance of the decorative feature can be varied by altering the elements used in each layer. Also, overlapping layers of different colours can produce new colours.

The typical decorative element will be 5-6 mm in thickness. The surface nearest the glass will be essentially flat however there may be a chamfers/curve on the edges due to design profile or manufacturing techniques. The opposite side of the decorative element can have concealed male/female fasteners or other small fasteners that will line up accurately with the internal side of another decorative element.

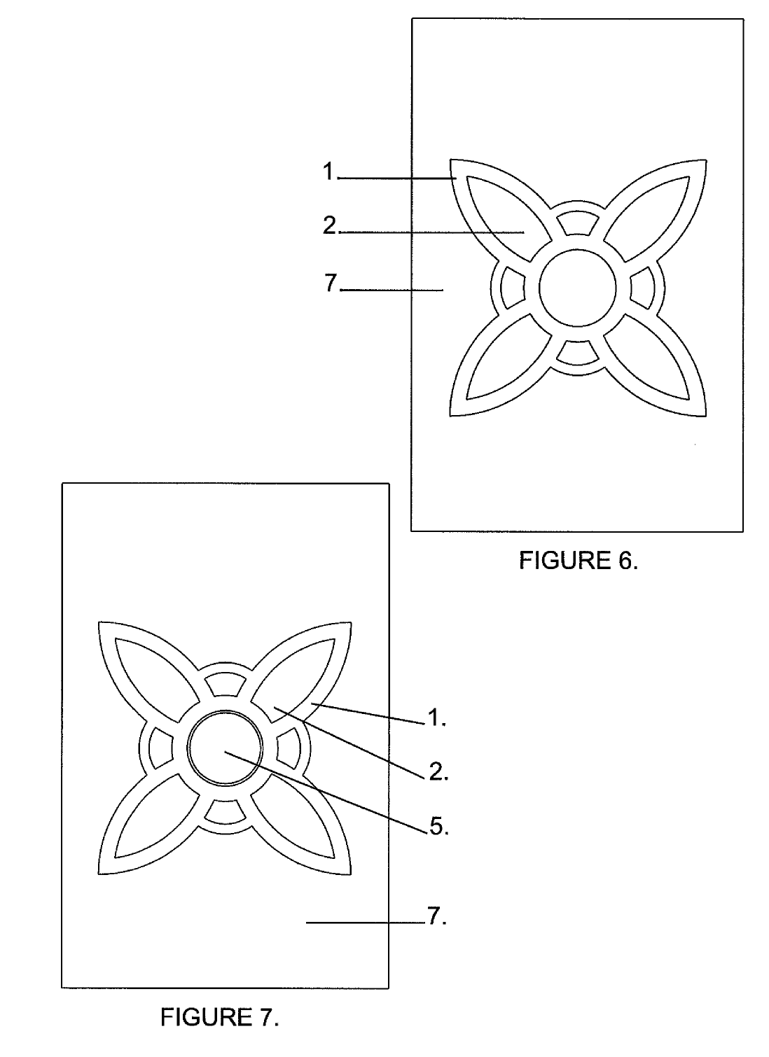

The decorative element can be attached to either side of the glass pane, where both sides of the glass pane are accessible. Where the glass pane has both internal and external faces e.g. on a house window, they are generally attached to the internal face of the glass. An example of an internal attachment arrangement is illustrated in FIG. 6. Additionally, FIG. 7 illustrates the view of an internally attached decorative element, when viewed from the opposite side of the glass pane. The difference between the FIG. 6 and FIG. 7 is the visibility of the clear double sided adhesive patch 5 attached to the existing glass pane 7 as illustrated in FIG. 7.

The frame 14 can have a pattern of apertures to allow the passage of light through from the existing glass window pane. It will be generally 5-6 mm in thickness, the thickness is determined by the design and manufacturing (this can be variable).

The external side of the decorative element (room side) may be relatively flat, however there may also be different profiles in some designs that match the shapes of lead, used in leaded and stain glass. Other profiles may be more modern and unusual (there may be a chamfer/curve on the edges due to design profile or manufacturing techniques). This side can also be relatively flat. The internal sides of portions 1 and 3 will have male/female or other small fasteners that will line up accurately with the internal side of portion 3. Where there are no clips or fasteners, generally an adhesive can be used or other alternative methods of attachment can also be used.

The decorative elements can be made by injection moulding, vacuum forming, CNC cutting devices and 3D printing also other manufacturing machinery. These decorative elements where possible will be manufactured using recycled materials. Other materials include sheet plastics, rubbers, wood, metals etc. Materials can be supplied in varying thicknesses, colour, textures, sheet form, pellets or other forms for the varying machinery involved.

Not all apertures of the frame 14 need to be filled by a lens (see FIG. 4). These areas can be open.

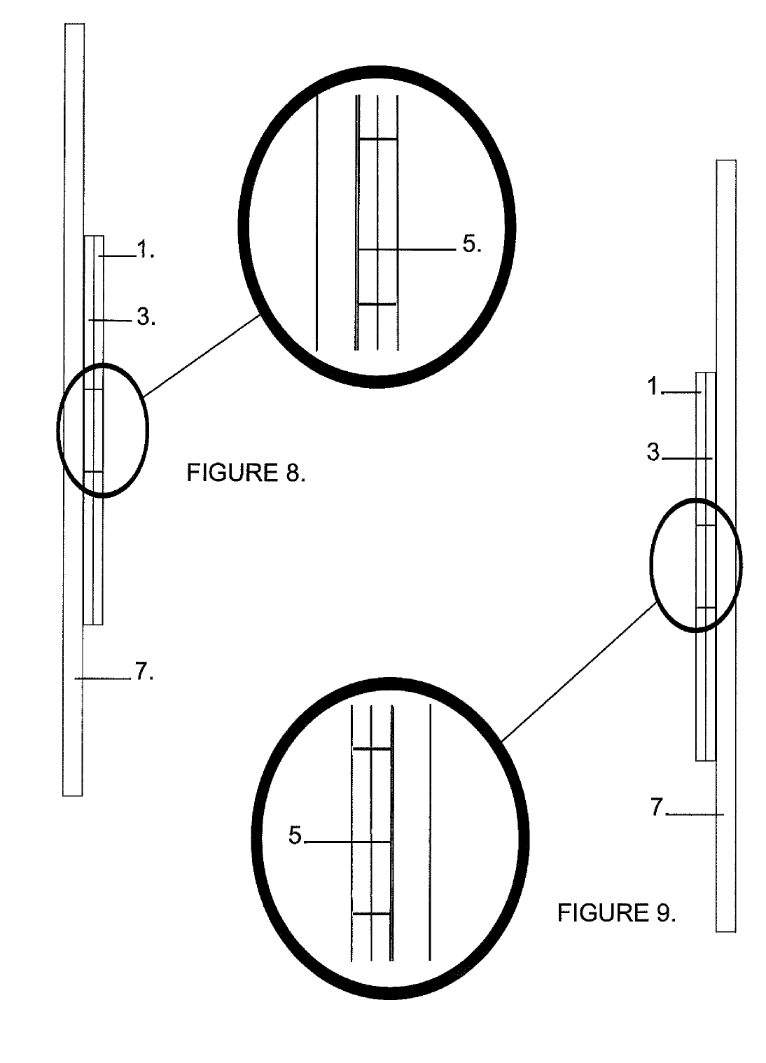

FIGS. 8 to 11 illustrate the adhesive as located in the centre of the decorative element. When the adhesive patch is applied on a circular portion of the decorative element, the decorative element can be rotated around this portion.

The enlarged details on FIGS. 8 to 11 illustrate the double-sided adhesive patches 5. They also show that the adhesives sits just proud of the decorative element, thus retaining a small amount of space between the rest of the decorative element and the existing glass pane. This feature provides enough space and eases the rotational capability of the decorative element. The decorative elements may have a recessed area to accept a variety of fasteners and adhesives, as illustrated on the decorative element in FIG. 13. The size of the adhesive patch or fastener will be smaller in diameter to allow the decorative element to rotate freely. FIG. 7 illustrates the double-sided adhesion patch 5. The adhesive patch or fastener can be variable in thickness, designed type, diameter, shape and colour.

The decorative element will have the adhesive (generally a double sided thick, clear patch) that is used to attach to the existing glass pane on the side where it attaches to the glass. This is preferably attached to the lens through a cut out/formed aperture, and will be thick enough to allow contact to be made with the existing glass pane.

The adhesive patches can be of varying strengths. A higher bond UV resistant acrylic based adhesive is preferred, but other adhesives may also be used along with other methods. The possible use of a perforated or non-perforated clear mask attached to the adhesive patch before application will dilute the area of adhesion, this may enhance the design and limit the amount of adhesive that makes contact with the glass.

The adhesive patches can be made to match a specific shape. Other location methods can be several adhesive patches this is will serve mostly on larger decorative elements and will help with the overall support, this will only allow rotation when the peripheral adhesives patches are released from the surface of existing glass panes, leaving the central patch (if there is one). These may be of a lower strength, they may have a perforated or non-perforated mask to allow a more easily removable nature when removing or rotating. Other methods of attachment include clear or coloured Velcro, double and single sided tapes of varying thicknesses, clear or coloured patches of varying shapes and thicknesses, other methods included, these can all be attached in several different ways to suit the design. Adhesive can also be applied when necessary to the layer nearest the attached surface or existing glass panes, where possible the method of attachment will be located in a recessed area of the decorative element, preferably smaller than the recessed area.

Thick Clear UV resistant double sided patches are the preferred form of attachment. These shaped patches are generally attached to the central area of the design (to allow rotation), the adhesive will be applied within this recess. The adhesive has a thin layer of release paper which is removed before the decorative element is attached to the existing glass pane. There is an optional clear or coloured perforated patch that may help in aesthetics and the removal of the decorative element which can be applied over the adhesive patch before application to a suitable surface or existing glass pane. This arrangement can be flexible to allow optimum adhesion in a smaller amount for the decorative element. Generally at least one fixing is provided, and in most circumstances that will be sufficient.

The final decision on the method, type and number of adhesive fixings is determined by the design. This includes colours, thicknesses and position of the fixing(s) means will vary depending upon the size and shape of the pane and/or decorative element, including multi layered features, these will generally be attached together by adhesive patches, (this can be one or multiple) other methods are also used. Multi layered features can be compiled by the use of fasteners and other methods of fixing. These can be concealed.

The decorative element can be coated or additives may be added at the manufacturing process.

Prior to attachment to the glass pane, it is recommended that this area on the glass is thoroughly washed and polished to remove any grease or dust thereon and to increase good contact with attachment means. Methylated spirit or other equivalent cleaning agents may be used and the pane thoroughly dried and polished ensuring no smears. The attachment means may have a release lining layer for protection of dirt and dust during transporting etc. This film should be removed and then the decorative element positioned and fixed onto the suitable surface or existing glass pane, making sure that all the positions are correct. The decorative element(s) may be simply and easily removed by prising them off gently with a blunt instrument, (i.e. a butter knife or a scraper knife.)

The decorative feature can also have layers that are made up of several components to create one design as illustrated in FIG. 17. In this illustration, the decorative feature comprises two layers, each layer comprising four quarter circle shaped components. The components are attached together side by side with a variety of small concealed fasteners or adhesives to create a single layer. This layer is then joined to the rotated opposing layer to create a single assembly. FIG. 17 illustrates a decorative two layer decorative feature, joined together with concealed fasteners.

The present invention provides a decorative element which can be removably attachable to existing glass panes. The elements can be disposable and inexpensive yet can significantly improve the overall appearance of the pane. The decorative elements can provide the appearance of stain or leaded glass and can have portions which allow light to pass through the pattern. The decorative elements can have portions cut or formed to allow the passage of light.

The present invention is suitable for attachment to any suitable surface including glass panes of a window, glass doors, mirrors, picture frames and the like. The present invention incorporating the frames and lenses can be produced to any design, colour, shape or size.

The elements can be arranged in a non-prescribed decorative pattern. Any time after installation, the elements can be removed, re-arranged or replaced to provide a renewed decorative pattern to the existing glass pane.

Whilst specific embodiments of the present invention have been described above, it will be appreciated that departures from the described embodiments may still fall within the scope of the present invention.

1. A decorative feature for a transparent surface comprising:
a plurality of decorative elements, each element comprising a main body comprising at least one substantially planar first portion or lens which at least partially allows the transmission of light,
wherein the decorative elements are interconnectable to form an assembly, the installed assembly comprising a plurality of layers of lenses, the plane of each lens being substantially parallel to the plane of the transparent surface.

2. The decorative feature as claimed in claim 1, wherein each lens is configured to allow the transmission of light at only particular frequencies or a range of frequencies wherein each decorative element comprises a plurality of lenses and the lenses are of a plurality of colours.

3. The decorative feature as claimed in claim 1, wherein the assembly includes layered lenses of different colour such that the light which has been transmitted through the layered lenses is of a different colour to the lenses, wherein the decorative elements are interconnectable such that the formed assembly comprises layers of lenses in which the lenses are offset or overlap with each other.

4. The decorative feature as claimed in claim 1, wherein each lens is coated or treated to provide UV resistance.

5. The decorative feature as claimed in claim 1, wherein the decorative element comprises a frame which includes an aperture for each lens and wherein the or each aperture includes a recess, groove, lip or the like for retaining the lens.

6. The decorative feature as claimed claim 1, wherein each decorative element is removably attachable to the transparent surface or to another decorative element.

7. The decorative feature as claimed claim 1, wherein each decorative element includes a fastening member for fastening the decorative element to the transparent surface or to another decorative element, wherein the frame includes an aperture for the fastening member, the aperture including a recess, groove, lip or the like for retaining the fastening member.

8. The decorative feature as claimed in claim 7, wherein the fastening member comprises a contact surface and fastening means, the fastening means comprising an adhesive applied to the contact surface, wherein the fastening member extends from a first side of the main body such that the contact surface is spaced from the main body to provide a gap when the decorative element is attached to the transparent surface or another decorative element.

9. The decorative feature as claimed in claim 8, wherein each frame defines a recess on a second opposing side of the main body for receiving the contact surface of an adjacent decorative element, wherein the contact surface of one decorative element is attachable to a base of the recess of an adjacent decorative element.

10. The decorative feature as claimed in claim 7, wherein the fastening member is rotatably attached to the main body such that, in use, the main body is rotatable relative to the transparent surface or relative to another decorative element of the assembly, wherein the fastening member is provided at a central location of the main body so that the main body is rotatable about its centre.

11. A decorative feature for a transparent surface comprising:
at least one decorative element comprising a main body and a fastening member for fastening the decorative element to the transparent surface,
wherein the fastening member is rotatably attached to the main body such that, in use, the main body is rotatable relative to the transparent surface.

12. The decorative feature as claimed in claim 11, wherein the main body is substantially planar, the plane being substantially parallel to the plane of the transparent surface, wherein the fastening member is rotatably attached to the main body such that, in use, the main body is rotatable within the plane of the transparent surface and, wherein the fastening member is provided at a central location of the main body so that the main body is rotatable about its centre.

13. The decorative feature as claimed in claim 11, wherein the decorative element is removably attachable to the transparent surface, wherein the fastening member comprises a contact surface and fastening means, wherein the fastening means comprises an adhesive applied to the contact surface.

14. The decorative feature as claimed in claim 11, wherein the fastening member extends from the main body such that the contact surface is spaced from the main body to provide a gap when the decorative element is attached to the transparent surface.

15. The decorative feature as claimed in claim 11, wherein the decorative element includes locking means for selectively locking the position of the main body relative to the fastening member and of an adjacent decorative element, wherein the locking means comprises a movable stop, fastener or grip or an adhesive.

16. The decorative feature as claimed in claim 11, wherein the decorative element comprises at least one lens which at least partially allow the transmission of light, wherein the lens is configured to allow the transmission of light at only particular frequencies or a range of frequencies.

17. The decorative feature as claimed in claim 16, wherein the decorative element comprises at least one frame which includes an aperture for each lens, wherein the or each aperture includes a recess, groove, lip or the like for retaining the lens.

18. The decorative feature as claimed in claim 17, wherein the frame includes an aperture for the fastening member, wherein the aperture includes a recess, groove, lip or the like for retaining the fastening member, wherein the fastening member comprises a lens.
